(19) United States
(12) Patent Application Publication
(10) Pub. No.: US 2007/0180069 A1
(43) Pub. Date: Aug. 2, 2007

(54) Management of component configurations in a computer system

(75) Inventors: Mobeen Syed, Attleboro, MA (US); Colin Matthias, Waltham, MA (US); Jan Rosen, Sutton, MA (US); Patrick Babcock, Sturbridge, MA (US); Marc F. Schultz, Sudbury, MA (US)

Correspondence Address: WOLF GREENFIELD & SACKS, P.C., 600 ATLANTIC AVENUE, BOSTON, MA, 02210-2206, US

(73) Assignee: Staples The Office Superstore, LLC, Framingham, MA (US)

(21) Appl. No.: 11/343,696

(22) Filed: Jan. 31, 2006

(51) Int. Cl. G06F 15/177; G06F 15/173

(52) U.S. Cl. 709/220; 709/223

(57) ABSTRACT

Methods and apparatus are provided for managing relationships between individual components and configurations assembled to fulfill requirements in a computer system. In one embodiment, a method is provided whereby a configuration which includes a set of components is dynamically modified to add an additional component, so that the additional component can communicate with at least some of the set of components to fulfill a requirement. In one illustrative implementation in a retail store environment, a cash register configuration is dynamically modified to incorporate a handheld scanning device during periods of high customer traffic, so that a store employee can use the scanning device to provide input to the cash register while it would otherwise have sat idle (e.g., while the cashier is bagging another customer's items).

### FIELD OF INVENTION

This invention relates to computer systems, and more particularly to techniques for managing the roles of individual components in providing functionality in computer systems.

### BACKGROUND OF INVENTION

Designing a computer system to fulfill user requirements usually involves negotiating a balance between effectively delivering functionality to users and incurring the cost of computing technology (e.g., hardware and/or software components). Consequently, the design process often involves making tradeoffs between these competing concerns. Some system architectures offer greater flexibility than others with respect to managing these tradeoffs, affording latitude in implementing a system that cost-effectively delivers functionality to users in a manner that fulfills their requirements.

The conventional client-server system architecture, wherein multiple clients communicate via a network with a server, is one example of a system architecture which affords flexibility. In a client-server system architecture, because a given application may execute on either the server or the client, a designer may generally choose from among three basic implementation models. In the first model, clients are essentially “dumb terminals” connected to a server that stores user data and executes all application code. In the second model, the server maintains data used by clients in a shared file system, but the clients execute the application. In the third model, the application is decomposed into presentation logic (e.g., delivered via a browser) that executes on the clients and business and database logic which runs on the server. The ability to choose from among these models provides the flexibility to select the most cost-effective way to deliver functionality to users and thereby maximize the investment in computing technology. Considerations may include the expense associated with equipping clients with sufficient processing capability to execute an application, and the expense associated with maintaining the application in one location (if implemented on the server) or in multiple locations (if running on the client). Implementing other conventional system architectures usually involves analogous considerations.

However, with all conventional system architectures, design flexibility can be limited by factors relating to the system components themselves. For example, component interdependency can influence design flexibility. For example, many applications are designed to run under a particular operating system (OS), which in turn is typically designed to run on hardware having particular physical characteristics (e.g., processor speed, memory, storage, etc.). Often, the vendor providing the OS is different than the vendor providing the hardware. Consequently, if either the OS or hardware requires modification, difficulties may arise. As an example, it is common for OS vendors to periodically release a new version and stop supporting an older version of the OS. When this occurs, many users that run the older OS version choose to upgrade to a newer version so that the version they run is supported by the vendor. However, because the user may run applications designed to run under the older OS version, the upgrade usually necessitates time-consuming reconfiguration and re-testing of the applications. Moreover, upgrading to a new OS version may necessitate the purchase of new hardware, since the new version may require physical characteristics that existing hardware does not possess. Even further, if the OS and application execute on multiple machines, the replacement of multiple hardware devices may be required. As a result, some investments in computing technology may be mandatory and not necessarily directly related to the cost-effective delivery of functionality to users.

### SUMMARY OF INVENTION

Applicants have appreciated that these and other concerns relating to investments in computing technology may be alleviated via a system architecture wherein the role of any individual system component, such as a component comprising hardware, software or a combination thereof, may be dynamically defined and flexibly adapted to suit any particular purpose or requirement. Consequently, a component may be deployed in a manner that best suits a user's needs at any given time, in a manner which maximizes the component's utility to the user. Because a component can be redeployed as a user's needs change, great flexibility is provided with respect to investments in computing technology.

One embodiment of the present invention provides a system for managing a deployment of components to fulfill a requirement. The system comprises: a responsibility controller operable to define a plurality of functions performed to satisfy the requirement, the plurality of functions being defined in a manner which does not include defining an association between each function and a respective component; a composition controller operable to define an affiliation between a plurality of components, the affiliation defining a configuration of the components, the configuration being organized to provide a capability to perform the plurality of functions to satisfy the requirement; and an orchestration controller operable to define a relationship between the plurality of functions defined by the responsibility controller and the configuration defined by the composition controller, such that the components in the configuration provide the capability to perform the functions to satisfy the requirement. In one embodiment, each of the responsibility controller, composition controller and orchestration controller is implemented via software.

Another embodiment of the invention provides at least one computer-readable medium having instructions recorded thereon, which instructions, when executed, perform a method for managing a deployment of components to fulfill a requirement. The method comprises acts of: (A) defining a plurality of functions performed to satisfy a requirement, the functions being defined in a manner which does not include defining an association between each function and a respective component; (B) defining an affiliation between a plurality of components, the affiliation defining a configuration of the components, the configuration being organized to provide a capability to perform the plurality of functions to satisfy the requirement; and (C) defining a relationship between the plurality of functions defined in act (A) and the configuration defined in act (B), such that the components in the configuration provide the capability to perform the functions to satisfy the requirement.

### BRIEF DESCRIPTION OF DRAWINGS

In the drawings, in which like numerals represent like components:

FIG. 1 is a block diagram depicting an exemplary system architecture according to one embodiment of the invention;

FIG. 2 is an activity diagram depicting an exemplary technique for registering a component with a registry service, in accordance with one embodiment of the invention;

FIG. 3 is a flowchart depicting an exemplary technique for managing relationships between components and configurations, in accordance with one embodiment of the invention;

FIG. 4 is a flowchart depicting an exemplary technique for determining the availability of a component for use in a configuration, in accordance with one embodiment of the invention;

FIG. 5 is a flowchart depicting an exemplary technique for preparing and transporting information generated by a component via a communications service, in accordance with one embodiment of the invention;

FIG. 6 is a flowchart depicting an exemplary technique for receiving information generated by a component at another component, in accordance with one embodiment of the invention;

FIG. 7 is a block diagram depicting an exemplary computer system on which aspects of embodiments of the invention may be implemented; and

FIG. 8 is a block diagram depicting an exemplary memory on which aspects of embodiments of the invention may be implemented.

### DETAILED DESCRIPTION

In accordance with one embodiment of the present invention, a system architecture is provided in which the role of any one or more system components, such as components comprising hardware, software, or a combination thereof, may be dynamically defined and/or flexibly adapted to suit any system requirement. (As used herein, the term “requirement” refers to any one or more functions, characteristics, settings and/or features of a system or component thereof). For example, a hardware component implemented as part of a first configuration to assist in fulfilling a first requirement may be dynamically repurposed and redeployed as part of a second configuration to assist in fulfilling a second requirement. In another example, an existing system may be dynamically reconfigured to incorporate one or more additional components, so that the new components may be deployed to satisfy a particular requirement of the system. In yet another example, a function performed by a first group of components may be reassigned to a second group of components, while the function is being performed, so that the function is performed by the second group of components instead. Once a system is reconfigured, any or all of its components may produce, receive and/or exchange information freely with other components to fulfill the requirement. Any component may be dynamically deployed to suit any requirement, and any system may be dynamically reconfigured and/or assembled, using any suitable quantity and type of component(s), as the invention is not limited in this respect.

Embodiments of the invention may be implemented in any of numerous ways. One illustrative example, described below, is implemented in a retail store environment. This example assumes that an existing set of components has been assembled and configured to perform cash register functionality. Components in this existing configuration may include hardware, such as a keyboard, monitor, central processing unit (CPU), bar code scanner and/or printer, and software, such as one or more application programs designed to perform logical processing associated with cash register functions.

In accordance with one embodiment of the invention, this existing cash register configuration may be dynamically modified, at any desired time, to incorporate additional components, which may comprise hardware and/or software. In one example, when there is a long line of customers waiting to purchase items at the cash register, the configuration may be dynamically modified to incorporate a wireless handheld scanning device, such that the scanning device may exchange information with other components in the cash register configuration to assist in performing cash register functionality. As an example, when a cashier is not actively using the pre-existing cash register components to perform a transaction (e.g., when he/she is bagging a previous customer's items), another employee may approach a customer in line and cause the configuration to be modified to include the scanning device. Once this occurs, the employee may use the device to scan the waiting customer's items, causing input to be provided on those items to other components in the configuration, thereby facilitating another transaction while those components would otherwise have sat idle. The other components in the configuration may process the input provided by the scanning device as if it were received from any other component in the configuration (e.g., the keyboard or scanner). For example, the monitor may display product information based on input provided by the scanning device, the CPU may process input from the scanning device to facilitate the transaction, and the printer may print a receipt for the transaction initiated by the scanning device. When the customer's transaction has been completed, the cashier may resume control of the cash register configuration by using the keyboard and scanner to execute another customer's transaction. When this occurs, the scanning device may remain in the configuration, or may drop out of the configuration to, for example, join another configuration (e.g., another cash register). In this manner, during peak shopping times when many customers are waiting to check out at a limited number of registers, components may be utilized in a manner which more aptly suits the business's needs (in this example, to perform a greater number of transactions in a given period, reducing the average customer's wait time).

It should be appreciated that the retail example given above is provided for illustration only, and that numerous other implementations are possible. Some possible implementations are described below. However, because embodiments of the invention may be implemented in any of numerous ways, the implementations described herein should not be construed as limiting. In this respect, in accordance with embodiments of the invention, any component(s) may be dynamically deployed and/or repurposed to suit any desired purpose, use and/or requirement, in any desired fashion.

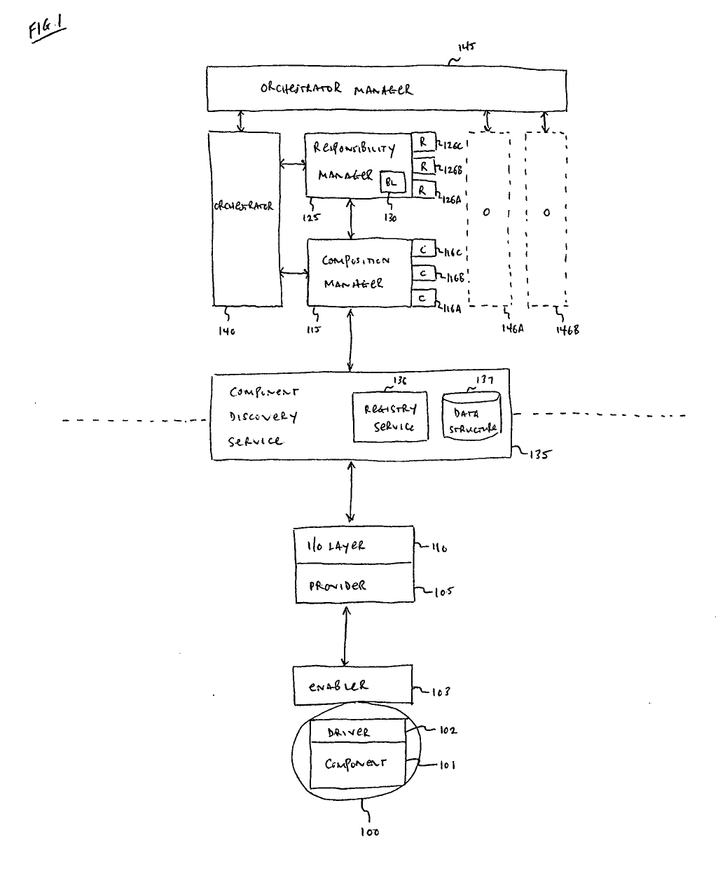

FIG. 1 depicts an exemplary architecture by means of which a component may be dynamically deployed as part of a configuration to fulfill a particular requirement. In the depicted architecture, a component comprises an individual “providable unit” 100 (hereinafter a “unit”). A configuration may consist of any desired quantity of units. As a result, the unit 100 which is shown in FIG. 1 may communicate with any number of other units (not shown in FIG. 1) in a particular configuration. The logical relationship between a unit and a configuration, and communication between units in a configuration, is managed by composition manager 115, responsibility manager 125 and orchestrator 140, in the manner described below. Unit 100 may communicate with composition manager 115, responsibility manager 125 and orchestrator 140 via component discovery service (CDS) 135.

In the exemplary architecture depicted in FIG. 1, unit 100 comprises a hardware component 101 (e.g., a peripheral device which receives user input and communicates with one or more other system components) which has a corresponding driver 102 to supply information on the functions of component 101 to other components. Those skilled in the art will recognize that driver 102 includes programmed instructions that, when executed, cause information on the functions of component 101 to be supplied to an external entity, such as the operating system of a computer. Driver 102 causes information from unit 100 to be communicated to enabler 103.

It should be appreciated that although component 101 comprises a hardware component in the exemplary architecture of FIG. 1, a component may comprise any one or more suppliers and/or receivers of information, including those formed of hardware, software, or a combination thereof. The invention is not limited in this respect. It should also be appreciated that in implementations wherein component 101 comprises one or more software-based components, driver 102 may not be required.

At a high level, in the architecture of FIG. 1 unit 100 communicates with one or more other components in a configuration by sending information via component discovery service (CDS) 135, whereupon the information is directed to the appropriate component(s). More specifically, unit 100 sends the information to communication enabler 103, which sends it to provider 105, which then sends the information via CDS 135 to composition manager 115, responsibility manager 125 and orchestrator 140. Processing performed by composition manager 115, responsibility manager 125 and orchestrator 140 identifies the other component(s) in a configuration to which the information is to be directed. Once the component(s) is(are) identified, the information is sent to the corresponding provider(s) 105, which then provides it to the corresponding enabler(s) 103 and ultimately to the appropriate component(s). This process is described in greater detail below.

Communication begins when unit 100 sends information to enabler 103. In one embodiment, enabler 103 adapts the information to comply with a communications protocol employed by the architecture. In one embodiment, a Unit Brokerage and Interaction System (UBIS) protocol, defined in Appendix A, is employed. However, it should be appreciated that any suitable communications protocol(s) may be used, as the invention is not limited to a particular implementation.

In one embodiment, enabler 103 comprises a set of programmed instructions that execute on a processor in unit 100 (e.g., in component 101). For example, in the illustrative retail store implementation described above wherein component 101 is a scanning device, enabler 103 may comprise instructions which execute on the scanning device's processor. However, the invention is not limited in this respect, as enabler 103 may be implemented in any suitable fashion. For example, when enabler 103 is implemented as programmed instructions, it may be executed on any suitable processor which communicates with unit 100. For example, if component 101 is a wireless device (e.g., a wireless printer) in communication with a computer, then enabler 103 may execute on the computer.

Once the information sent by unit 100 is adapted for communication via the protocol by enabler 103, it is passed to provider 105. The information sent by enabler 103 to provider 105 may be sent in any suitable fashion and form. As an example, information may be communicated to provider 105 in XML or binary format, as a file or any other type of data structure, via a TCP/IP or other protocol. Information may be sent, for example, in encrypted form, using any suitable encryption algorithm(s).

Provider 105 then processes the information sent by enabler 103 to attach metadata identifying unit 100 as the source of the information. The metadata may also provide various details on unit 100, such as its physical characteristics (e.g., its processing capability or memory availability), its location (e.g., its geographic location and/or location within a particular store), and/or other characteristics. This metadata may, for example, be employed by composition manager 115 and responsibility manager 125, in a manner described in further detail below.

Provider 105 may optionally apply various transformations to the information via I/O transformation layer 110. Generally, these transformations are applied after unit 100 is deployed as part of a configuration. For example, provider 105 may apply a transformation to make the information from unit 100 conform to a specific format that is expected by a recipient component. In one embodiment, transformations may include re-formatting information (e.g., by padding binary data with zeros to produce a field of expected length), translating information (e.g., so that it is changed from binary to XML format), reflecting information (e.g., so that it is sent to a recipient component other than the one intended by unit 100), and/or replicating information (e.g., so that it is copied and sent to multiple recipient components). Exemplary uses for these and other data transformations are described in detail below. Information is then passed to CDS 135.

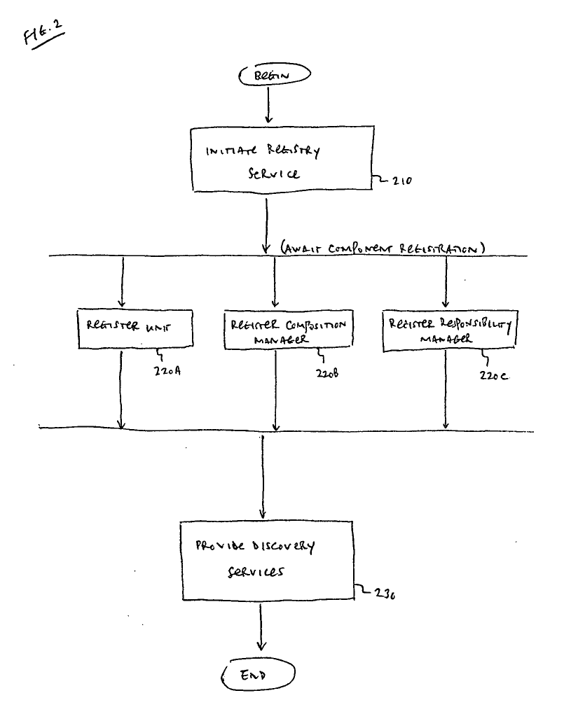

Overall, communication via CDS 135 requires registration with a registry service 136 provided by CDS 135. Those skilled in the art will recognize that a registry service is a mechanism whereby components in communication via a network may ascertain the presence and/or availability of other components for communication. Typically a registry service is implemented as software. FIG. 2 is an activity diagram which depicts an exemplary process by means of which a unit 100, as well as other system resources including composition manager 115, responsibility manager 125 and orchestrator 140, may register with registry service 136.

Upon the start of the process, the registry service 136 of CDS 135 is initiated in act 210. The process then proceeds to acts 220A-220C, wherein any number of units (including unit 100), composition managers 115 and responsibility managers 125 may communicate with the service to register. In one embodiment, an indication of the registration of any or all of the registered resources may be maintained in data structure 137 maintained by CDS 135.

In one embodiment, when a unit registers with the service, it may provide an indication of its location. A location may, for example, be geographically defined, as specifically as desired. For example, a unit's location may be defined as generally as “Massachusetts” or “Framingham”, or as specifically as “in the general manager's office” or “in lane 1”. A location may be defined in any suitable manner, as the invention is not limited in this respect. An indication of a unit's location may, for example, be stored in data structure 137 maintained by CDS 135.

Upon the completion of acts 220A-220C, CDS 135 provides discovery capabilities in act 230. Discovery capabilities are well-known to those skilled in the art. In general, discovery capabilities enable components that have registered with the registry service 136 to query CDS 135 to determine the availability of other components. For example, a component may discover whether another specific component (e.g., a particular hardware device) has registered, or whether any components have registered which are capable of performing a specific function (e.g., devices having print capabilities).

Referring again to FIG. 1, once unit 100 has registered with CDS 135, information may be passed between provider 105 and composition manager 115 (assuming it also has registered) via CDS 135, and from composition manager 115 to responsibility manager 125 and orchestrator 140.

At a high level, in the exemplary architecture shown, composition manager 115 defines the constituent components for each configuration deployed by the system in the form of a composition 116. Responsibility manager 125 defines the logical processing for fulfilling each business function performed by the system, in a manner that is independent of the actual components that may perform these functions, in the form of a responsibility 126. A composition 116 and responsibility 126 may comprise, for example, an arrangement of data such as a record maintained in a data structure. Any number of compositions 116 and/or responsibilities 126 may be defined. Orchestrator 140 defines logical relationships between one or more compositions 116 and one or more responsibilities 126. A composition 116 may have any suitable relationship with a responsibility 126. For example, a single composition 116 may be associated with multiple responsibilities 126, multiple compositions 116 may be associated with a single responsibility 126, and/or multiple compositions 116 may be associated with plural responsibilities 126.

The detailed functions of composition manager 115, responsibility manager 125 and orchestrator 140 are illustrated below using the aforementioned example of the cash register configuration which is modified to incorporate a scanning device. Again, this example assumes that each component in the existing cash register configuration has previously been defined as a unit whose function and role may be dynamically defined.

In this example, composition manager 115 defines multiple compositions 116. A first composition 116A (in this example, named “Physical Register 1”) includes the hardware components that comprise the pre-existing cash register configuration, including a keyboard, monitor, scanner and printer, and one or more software components that execute point-of-sale processing logic. A second composition 116B (named “Handheld 1”) includes the scanning device. Although FIG. 1 depicts only three compositions 116A-116C, composition manager 115 may define any quantity of compositions, as the invention is not limited in this respect.

As described above, responsibility manager 125 defines business functions and the way in which they are performed in a manner that is independent of the components that may perform the functions. In this example, responsibility manager 125 defines a cash register responsibility 126A (named “POS Register 1”) which includes various functions typically associated with a cash register, including accepting bar code input, processing point-of-sale transactions, visually displaying item information, and other functions. In this example, responsibility manager 125 also defines the processing performed for these functions (i.e., business rules 130). For example, responsibility manager 125 may define that bar code information (e.g., received by a scanner) is communicated to an application program that performs item identification (e.g., by performing a lookup on a product information database using decoded information). It may also define that once an item is identified, information on the item is passed to a monitor for display to a customer. A responsibility 126 may define any type and quantity of processing. Further, although only three responsibilities 126 are shown in FIG. 1, responsibility manager 125 may define any number of responsibilities.

Orchestrator 140 defines relationships between compositions 116 and responsibilities 126. For example, orchestrator 140 may define an initial relationship between responsibility 126A (“POS Register 1”) and composition 116A (“Physical Register 1”), allowing components in composition 116A to perform cash register functions in the manner defined by responsibility 126A.

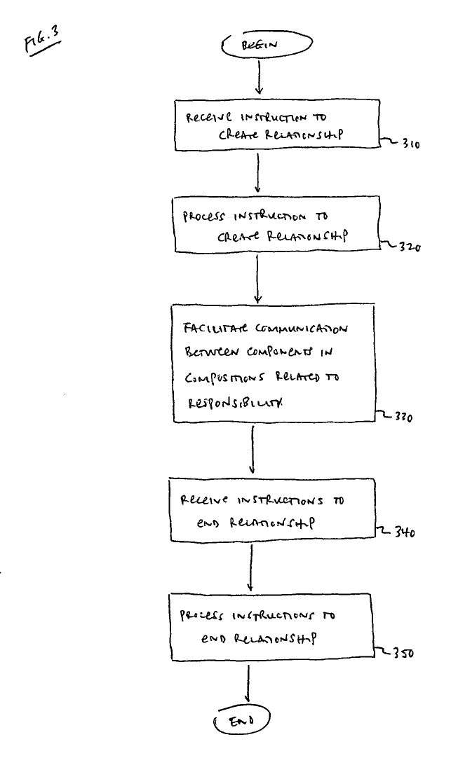

Orchestrator 140 also modifies relationships between responsibilities 126 and compositions 116. For example, orchestrator 140 may modify a relationship between a composition and a responsibility in response to receiving an instruction to do so. Instructions may be provided, for example, by a component such as the scanning device, such that the scanning device may initiate its own incorporation into an existing configuration. For example, the scanning device may issue an instruction to orchestrator 140 when store conditions warrant (e.g., when customer checkout times are outside an acceptable range). An process which may be performed in response to store operating conditions is shown in FIG. 3.

Upon the start of process 300, an instruction is received in act 310 to create a relationship between a composition 116 and a responsibility 126. For example, an instruction may be received by orchestrator 140 to create a relationship between composition 116B (which includes the scanning device) to responsibility 126A (to which composition 116A is already assigned).

In act 320, the instruction is processed. For example, orchestrator 140 may process the request and create a relationship between composition 116B and responsibility 126A. As a result, the scanning device and cash register components are each providable units 100 assigned to responsibility 126A, such that they share responsibility 126A. In this respect, the components in compositions 116A and 116B form a new configuration which includes the components in compositions 116A and 116B, and which is assigned to perform the functions defined by responsibility 126A.

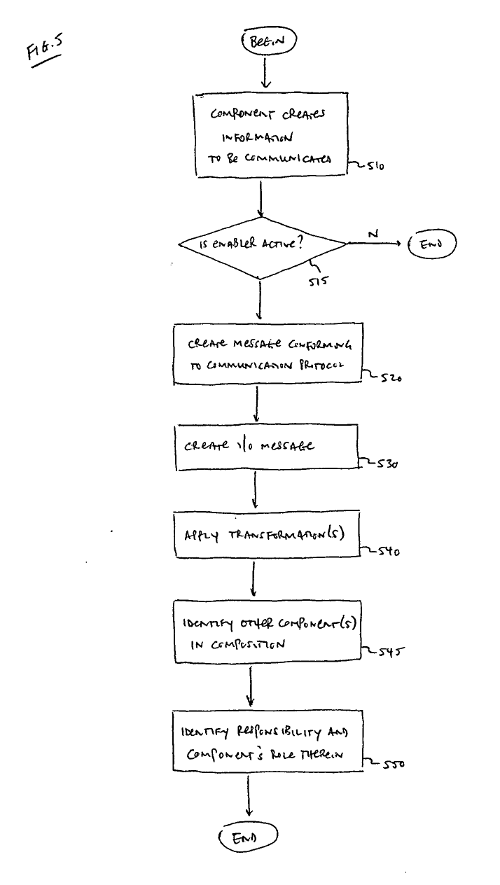

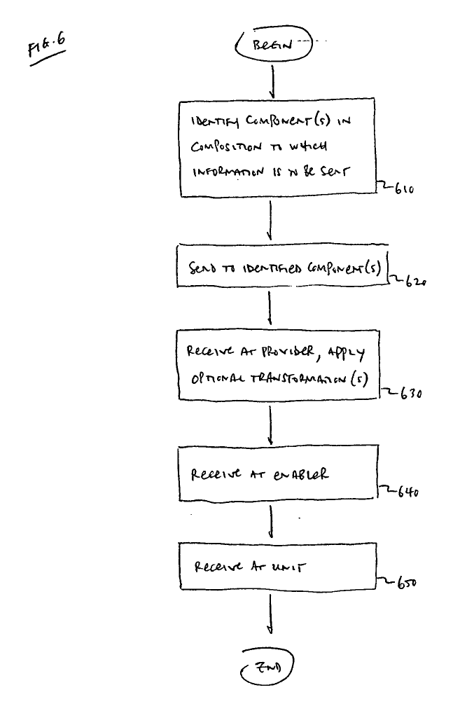

In act 330, communication is facilitated between one or more of the components in compositions 116A and 116B, which are both assigned to responsibility 126A. For example, information from a component in composition 116A may be sent via the unit's enabler 103 and provider 105 to CDS 135, and from CDS 135 to composition manager 115 and orchestrator 140. Upon determining that composition 116A is assigned to responsibility 126A, orchestrator 140 may cause the information to be sent to the components in other compositions also assigned to responsibility 126A (i.e., composition 116B, which includes the scanning device). Information from one or more components in composition 116B may be communicated to components in composition 116A using the same technique. Communication between units is described in greater detail below with reference to FIGS. 5 and 6.

As a result of creating a new relationship between composition 116B and responsibility 126A, components in compositions 116A-116B may communicate with each other to perform the functions defined by responsibility 126A. For example, an application program in composition 116A may begin receiving input from the scanning device in composition 116B and cause it to be displayed on the monitor in composition 116A. Any information generated by the scanning device may be sent to, received at, and/or processed by other components in the composition assigned to the responsibility, as if the scanning device were physically attached to the register. The input provided by the scanning device in composition 116B may be processed instead of, or in addition to, other input provided by components in composition 116A.

Also, information produced by cash register components in composition 116A may be communicated to the scanning device in composition 116B. For example, information gathered as a result of a lookup on a product information database by an application program in composition 116A may be sent to and displayed by the scanning device in composition 116B, such that the scanning device may be provided with a “view” of the transaction as it is processed.

Any number and type of components may be assigned to, and receive communication related to, a responsibility. For example, a component such as an application program running on a separate computer may also be assigned to responsibility 126A (i.e., in addition to the components in compositions 116A and 116B), so that it may “listen in” on communication passed between other components assigned to the same responsibility, such as communication relating to a transaction in progress. This may be useful, for example, for loss prevention, system support, and/or other purposes. For example, a loss prevention officer may observe a transaction in progress to confirm that all items brought by a customer to the register are included in a transaction, or a system administrator may listen in on communication between components if one component behaves abnormally to diagnose an issue with that component.

In act 340, an instruction is received to end the relationship between the composition and the responsibility. For example, at an appropriate time (e.g., when customer wait times are within an acceptable range), the scanning device may issue an instruction to orchestrator 140 to end its association with responsibility 126A.

In act 350, the instruction is processed, and orchestrator 140 ends the relationship between composition 116B and responsibility 126A, such that only composition 116A is assigned to responsibility 126A. As a result, information is no longer passed from cash register components in composition 116A to the scanning device in composition 116B, or vice versa. Upon the completion of act 350, the process 300 completes.

Instructions to begin, end or otherwise modify relationships between compositions and responsibilities may be issued in any suitable fashion. For example, an instruction may be issued in response to user input and/or generated automatically (e.g., by an automated agent that adjusts relationships in response to operating conditions).

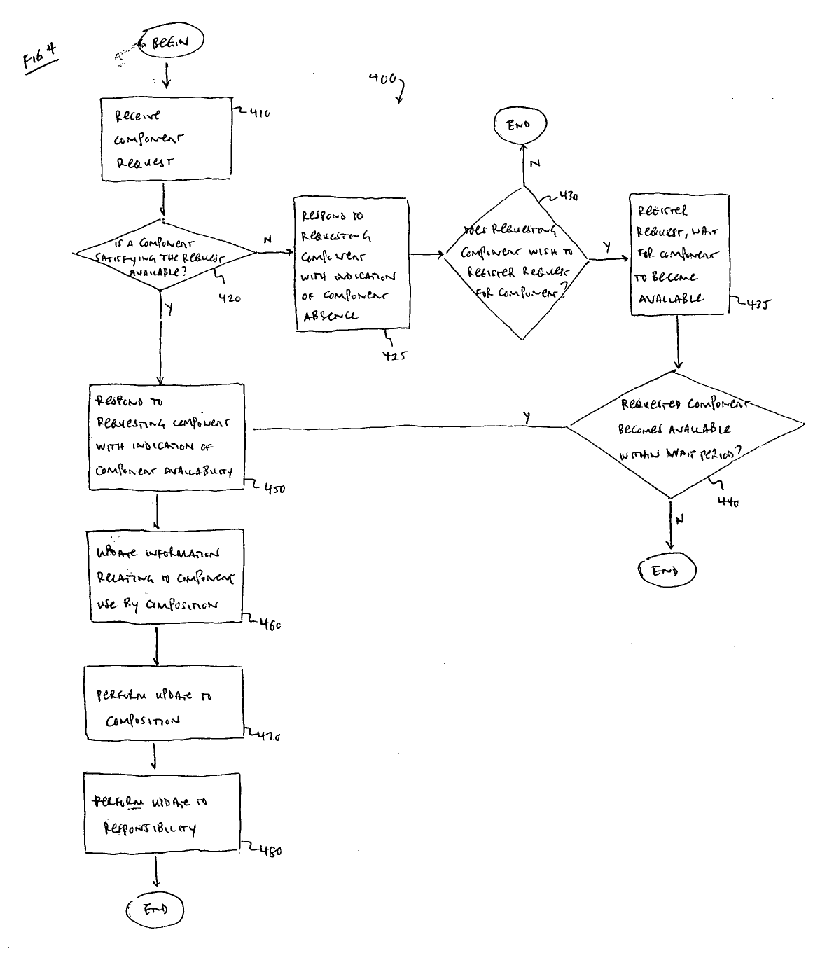

Moreover, instructions may be issued by any component. For example, instead of being issued by a device seeking to join or be assigned to a responsibility (as with the scanning device described above), a component that is already assigned to a particular responsibility may seek to add another component, such as to perform a particular task or provide particular functionality. For example, if one component in cash register composition 116A (e.g., a program module) fails, another component in the composition may seek a substitute to take its place. A process 400 by means of which a component may seek another component to join a composition in fulfilling a responsibility is shown in FIG. 4.

Upon the start of process 400, a request for a component is received in act 410. This request may be received, for example, by CDS 135. The request may specify specific criteria for the component. For example, the request may identify a specific program module, and specify that it must be stored on a computer located at the “Framingham” location. The request may also specify the composition and/or responsibility to which the requesting component is assigned.

In act 420, a determination is made whether a component satisfying the request is available. For example, CDS 135 may access information supplied by provider 105 and stored in data structure 137 to determine whether a component satisfying the request criteria is available for use.

If it is determined that a component satisfying the request is not available, the process proceeds to act 425, wherein an indication of the absence of the specified component is provided to the requesting component. The process then proceeds to act 430, wherein a determination is made as whether the requesting component wishes to register the request for the component. For example, CDS 135 may communicate a query to the requesting component to determine whether the request should be registered. If it is determined that the request should not be registered, process 400 ends. If it is determined that the request should be registered, the process proceeds to act 435, wherein the request is registered (e.g., an indication of the request may be stored in data structure 137), and a wait for the requested component begins. The wait may continue for any suitable period, such as one defined by a predefined time limit, or any other suitable event or occurrence. If the requested component does not become available within the wait period, the process completes. If the requested component does become available, the process proceeds to act 450.

In act 450, a response is sent to the requesting component indicating that a component which satisfies the request is available. In act 460, information relating to the use of the component by a composition is updated. Component use information may be stored, for example, in data structure 137. The data structure may, for example, be updated to reflect the composition and/or responsibility of the requesting and/or newly consumed component.

In acts 470 and 480, a composition and/or responsibility is updated to reflect a newly formed relationship between the requested component and an exiting composition and/or responsibility, respectively. For example, in act 470, composition manager 115 may update a composition 116 to reflect the assignment, and in act 480, responsibility manager 125 may update a responsibility 126 to reflect the assignment. Upon the completion of act 480, the process completes.

FIGS. 5 and 6 depict exemplary processes by means of which one component may communicate with another. Specifically, FIG. 5 depicts a process 500 which is performed to transmit information from a component, and FIG. 6 depicts a process 600 whereby a component receives information from another. Either or both of processes 500 and 600 may be performed by executing programmed instructions, which may be executed, for example, on any or all of component 101, CDS 135, composition manager 115, responsibility manager 125 and orchestrator 140, shown in FIG. 1.

Upon the start of process 500 (FIG. 5), a component creates information in act 510 which is to be communicated to another component. For example, a component 101 associated with a given composition and/or responsibility may generate output that is to be directed to another component associated with the same composition and/or responsibility.

In act 515, a determination is made whether the enabler 103 for the component is active. For example, a component 101 may execute programmed instructions to determine whether its enabler 103 is active. The enabler may not be active, for example, to remove the component's ability to communicate with other components. For example, if the component is malfunctioning and producing meaningless data, its enabler may be deactivated to avoid tying up network bandwidth with this data. If it is determined in act 515 that the enabler is not active, the process ends.

If it is determined that enabler 103 is active, the process proceeds to act 520, wherein information generated by component 101 is used to create an output message that conforms to a communication protocol used by CDS 135. For example, enabler 103 may execute programmed instructions to create an output message which conforms, as an example, to the communication protocol described in Appendix A. At the completion of act 520, the process proceeds to act 530, wherein an I/O message is generated for communication to CDS 135. For example, provider 105 may execute programmed instructions to generate the I/O message from the output message generated in 520. As described above, the I/O message may include metadata identifying the component as the source of the I/O message, and/or provide various information on the component, such as its physical characteristics, location, and/or other information.

In act 540, one or more transformations may be applied to the I/O message generated in act 530. For example, provider 105 may execute programmed instructions comprising I/O layer 110 to apply one or more transformations to the I/O message. As described above, transformation may include any, all or none of replication (e.g., sending a message directed to a single component to multiple recipient components), translation (e.g., modifying the format of the message, such as from XML to binary format, for more efficient transport), reflection (e.g., redirecting the message from the component for which it is intended to a different unit, such as to debug the transmitting unit by examining its output) and/or reformatting (e.g., modifying the message so that it conforms to the format expected by the recipient component, such as by padding binary data with extra zeroes).

In one embodiment, I/O layer 110 may define separate subsystems which each perform different transformation functions. The subsystems may be invoked as required (e.g., by provider 110) so as to conserve processing resources. For example, if an I/O message does not require replication, a subsystem designed to perform replication may not be invoked, so as to avoid unduly occupying processing resources by executing instructions in that subsystem.

Upon the completion of act 540, the process proceeds to act 545, wherein one or more other components also associated with the transmitting component's composition are identified. For example, the output of act 540 may be sent via CDS 135 to composition manager 115, which may examine metadata attached to the message to determine that component 101 is the source of the message and determine whether component 101 is currently associated with an existing composition 116. If so, the composition is identified.

In act 550, a responsibility 126 with which the component 101 is associated is identified and its role in fulfilling the responsibility is determined. Responsibility 126 defines the role of component 101 in fulfilling a business function, as well as how information received from component 101 should be utilized. For example, responsibility 126 may define the overall business function of a cash register, and may define how information received from a component in the role of component 101 should be treated in fulfilling that business function. For example, responsibility 126 may define that information sent by a component in the role of component 101 (e.g., a peripheral scanning device) should be transmitted to another component associated with the responsibility, so that the other component may employ that information in some way (e.g., to perform a lookup on a product information database).

Upon the completion of act 550, the process 500 completes. In one embodiment, the results of act performed in process 500 are used in the performance of process 600 in FIG. 6. For example, the identification of how information sent by component 101 should be treated by responsibility manager 125 in act 550, and the identification of a relationship between component 101 and other components in a composition 116 in act 545, may be used to identify the components to which the information originating from component 101 should be transmitted in fulfilling a particular business function. In this respect, process 600 may continue process 500, and may include the performance of many of the same acts performed in process 500, albeit in reverse order. For example, just as process 500 includes acts performed to move information from the bottom of the configuration shown FIG. 1 to the top (i.e., from unit 100 to responsibility manager 125), process 600 includes acts performed to move the information from the top of the configuration of FIG. 1 to the bottom (i.e., from responsibility manager 125 to one or more units 100).

At the start of process 600, the use of information in the fulfillment of a responsibility 126 has been identified (e.g., in act 550 of process 500). Once process 600 begins, an indication of this use is provided in act 610 to composition manager 115, which employs the indication to determine the component(s) to which information should be sent. Using the example given above, based on an identification that information from a peripheral scanning device (e.g., component 101) should be sent to another component that uses the information to perform a lookup on a product information database, composition manager 115 may identify the specific component (e.g., an application program) which performs this lookup in act 610. The identification is based, at least in part, on the composition 116 with which the component 101 is associated, such that an application program also associated with composition 116 is identified in act 610.

In act 620, the information is sent via CDS 135 to the identified component. In act 630, the information is received by the provider 105 corresponding to the identified component. In one embodiment, one or more transformations may be applied to the information by provider 105. For example, provider may execute programmed instructions comprising I/O layer 110 to transform the information into a format expected by the identified component. This transformation applied by the provider 105 associated with the receiving component may be performed instead of, or in addition to, any transformation applied by the provider 105 associated with the originating component 101.

In act 640, the information is transferred from provider 105 to enabler 103. Then, in act 650, the information is transferred to the receiving unit, whereupon it may be processed by that unit. For example, if the receiving unit comprises an application program which receives information from a scanning device, the application program may process the information to perform a lookup on a product information database, such as to identify a product scanned by the scanning device. Upon the completion of act 650, the process completes. Of course, the receiving component may generate output which is to be transferred to another component, and such a transfer may be completed using the processes 500 and 600 shown in FIGS. 5 and 6.

As mentioned above, embodiments of the invention may be implemented in any of numerous ways. One illustrative implementation may be implemented in a retail store environment for security and/or loss prevention purposes. For example, an security or loss prevention officer in a store may employ a device, such as a personal digital assistant (PDA) with wireless communication capabilities, to issue an instruction to incorporate the device into a configuration such as a cash register. Once the device has been incorporated into the configuration, information communicated between other components in the configuration may be monitored by the officer via the device. In this manner, the officer may monitor transactions (such as by “listening in”) and/or the actions of employees and/or customers.

Another illustrative implementation may allow system support staff to monitor and adjust aspects of system performance in real time. For example, if an employee reports that a device (e.g., a bar code scanner that is part of a cash register configuration) has stopped working properly, then information generated by the device may be re-routed so that it no longer is received by the components in the cash register configuration, and instead is received by a support application. The support application may examine the information generated by the device and assist support staff in determining the reason for the device's malfunction.

Yet another illustrative implementation may allow functional responsibilities to be shifted between components in a system. For example, if a device is malfunctioning, the functionality normally provided by that device may be provided by another device. For example, if a bar code scanner which provides functionality to a particular configuration fails during a transaction, an instruction may be issued to remove that scanner from the configuration and add another to complete the transaction. For example, a system support staff member may issue the instruction, such as by using a device in communication with a system resource which manages the relationship between compositions and responsibilities (e.g., orchestrator 140, shown in FIG. 1). Alternatively, a software agent may monitor the activities and output of components deployed in the system, automatically detect that a device is malfunctioning, and swap out that device for another.

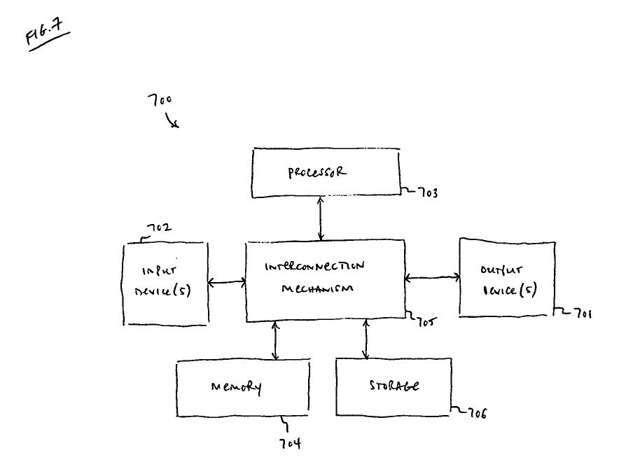

Various aspects of embodiments of the invention may be implemented on one or more computer systems, such as the exemplary system 700 shown in FIG. 7. Computer system 700 includes input device(s) 702, output device(s) 701, processor 703, memory system 704 and storage 706, all of which are coupled, directly or indirectly, via interconnection mechanism 705, which may comprise one or more buses or switches. The input device(s) 702 receive input from a user or machine (a human operator) and the output device(s) 701 display(s) or transmit(s) information to a user or a machine (e.g., a liquid crystal display).

The processor 703 executes a program called an operating system which controls the execution of other computer programs, and provides scheduling, input/output and other device control, accounting, compilation, storage assignment, data management, memory management, communication and data flow control. The processor 703 and operating system define the platform for which application programs and other computer programming languages are written.

The processor 703 may also execute one or more programs to implement various functions, such as those which embody aspects of the invention. These programs may be written in a computer programming such as a procedural language, object-oriented language, macro language, or combination thereof.

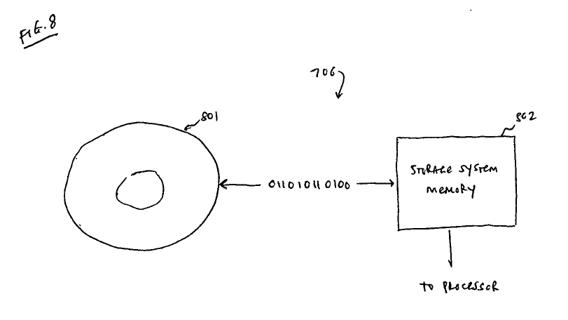

These programs may be stored in storage system 706. The storage system may hold information on a volatile or non-volatile medium, and may be fixed or removable. Storage system 706 is shown in greater detail in FIG. 8. It typically includes a computer-readable and -writable non-volatile recording medium 801, on which signals that define the program, or information to be used by the program, are stored. The medium may, for example, be a disk or flash memory. Typically, in operation, the processor 803 causes data to be read from the non-volatile recording medium 801 into a volatile memory 802 (e.g., a random access memory, or RAM) that allows for faster access to the information by processor 803 than does the medium 801. Memory 802 may be located in storage system 706, as shown in FIG. 7, or in memory system 804, as shown in FIG. 8. The processor 703 generally manipulates the data within the integrated circuit memory 704, 802, and then copies the data to the medium 801 after processing is completed. A variety of mechanisms are known for managing data movement between the medium 801 and the integrated circuit memory 704, 802, and the invention is not limited thereto. The invention is also not limited to a particular memory system 804 or storage system 706.

It should also be appreciated that the above-described embodiments of the invention may be implemented in any of numerous ways. For example, the above-discussed functionality may be implemented using software, hardware or a combination thereof. When implemented in software, the software code can be executed on any suitable processor or collection of processors, whether provided in a single computer or distributed among multiple computers. It should further be appreciated that any component or collection of components that perform the function as described herein may generically be considered as one or more controllers that control the above-described function. The one or more controllers may be implemented in numerous, such as with dedicated hardware, or by employing one or more processors which are programmed using microcode or software to perform the functions recited above. Where a controller stores or provides information for system operation, such information may be stored in a central repository, in a plurality of repositories, or a combination thereof.

Having thus described several aspects of the at least one embodiment of this invention, it is to be appreciated the various alterations, modifications, and improvements will be readily appreciated by those skilled in the art. Such alterations, modifications and improvements are intended to be part of this disclosure, and are intended to be within the spirit and scope of the invention. Accordingly, the foregoing description and drawings are by way of example only.

### APPENDIX A

### Exemplary Communications Protocol Specification

Introduction:

This protocol involves messages flowing between different components of the system. Some of the message types are administrative, control, configuration, performance monitoring, metadata and data. Messages can flow from one PU to another directly or through a stack of layers performing designated operations on it. Messages can be generated from different layers of this system but eventually effect one or more end points. A message entering in the system can eventually cause zero-many messages.

Concepts and Definitions:

this protocol needs following concepts and definitions to be adhered to

PU: A providable unit, this can be hardware or software system which can takes part in the system as a unit of activity.

End Point: An end point is any this layer which will consume or generate a message.

Mid Point: A mid point will be any layer allowing a message to be passed through or transforms replicates or suppresses a message which is traveling towards an end point through this layer.

Message Classification:

This document is primarily concerned with providing a message classification and the content specifications without providing a message implementation in any particular way. Messages routing through the system can be understood by documentation following flags

Level:

This flag will determine the layer which contains the end point from where this message is allowed to originate from. A message which originates from one end point and reaches another without being touched while traversal will be called full and partial otherwise. Level number starts from enabler and increases upward lateral expansion will not be included in level and will be indicated by life flag.

Effect:

Broadly speaking all messages can be divided into three types of effectors internal external and hybrid

Internal Effecter: A message which alters the state/behavior of the system however minimal it might be.

External Effecter: A message which uses system as a delivery service and has effect only on the end point(s) it hits.

Hybrid Effecter: A message which causes is both internal and external in its effect.

Distance:

Distance describes the message's origin, termination and hop behavior, we can have messages with following distances

End to End: A message which originates from one PU and ends at another PU and is External or Hybrid effecter

End to Mid: A message which comes from a PU but is stopped/consumed by layers

Mid to Mid: A message which originates from layers and is consumed by layers.

Mid to End: A message originating from layers but is consumed by a PU and can act as an external effecter.

Life:

Messages can have following life spans

Cyclical: A message which travels the system and hits a layer more than once

A-Cyclical: A message which traverses layers in a linear fashion and does not hit a layer more than once.

Spatial: A message which works with more than one units of the same type but is not endlessly cyclical

Security:

Security requirements for the message while it traverses through layers

Size:

Size factor for a message, where possible a maximum size allowed with a thresholding processing power can be described.

Frequency:

Frequency of a message can increase or decrease the impact of the message on system performance an exact or tentative idea must be provided about the frequency of a message and a thresholding processing power can be tied as a dependency.

Importance:

How important a message may be for the processing and stability of the system? Greater the importance value more impact the message has on the system. An external effecter will carry highest importance in all cases without effecting the system, as the system is in fact working for the external effecters.

Marshalling/Un-Marshalling Impact:

Every message in the document will be tied to a marshalling and un-marshalling impact e.g. an XML message should be tested through different parser implementations to check for performance impact more than one type of message implementations and their impacts must be specified. Document will dictate what impact level is acceptable for which message. We will use following key as impact level measurement
1. Large Impact: A message which can take up more than 5% of the system resource capacity while it passes through the system.
2. Moderate Impact: A message which can take between 1-5% of the system resource capacity while it passes through the system.
3. Fair Impact: A message which can take between 0.1-1 percent of the system resource capacity while it passes through the system.
4. Small: A message which will take lesser than 0.1% of the system resource capacity whiles it passes through the system.
   Expected Traversal Time (ETT):

Time in milliseconds or other suitable units needed for this message to traverse through the system for a particular thresholding configuration. Note ETT must include all times through the system e.g. network layers time plus processing time etc.

Allowable Traversal Time (ATT):

Maximum time in milliseconds or other suitable units allowed for this message to traverse through the system after which the next layer which processes it can through it out or a time out can be called and message discarded when received. Note ATT must include all times through the system e.g. network layers time plus processing time etc.

Knowledge Base for Message:

Some messages can not originate or be processed if a particular knowledge item is not known e.g. if a provider's name is not known an enabler can not connect. Such required elements will be described under knowledge base for the message.

High Level Message Descriptions

Messages mainly are originated and consumed by the providable units qualifying as full level external effectors, but many admin and other messages can originate and terminate at different intermediate layers qualifying as partial level internal messages. Below is a description of the most of the messages necessary for the system to function. Note that the messages are not specified in final shape only a description and suggested or required contents are laid out, order, packing and format of the message will be implementation specific and does not matter.

Messages from Enabler:

The enabler layer can provide admin and data messages, admin messages to allow the providable unit it wraps to participate in the system and data message or external messages as they originate from the providable unit itself. Following are the message specifications

Admin Messages

These can include incoming and outgoing messages for following purpose

a) Join/Leave

b) Enable/Disable/Pause the PU into the system

Join - Leave Messages

| Layer Name | Enabler |
|---|---|
| Description | These messages will originate at the beginning and the |
| | end of a PU's participation session. Messages must |
| | contain Joining or leaving flag. Once a PU joins the |
| | system it must provide it's name and locale e.g. Scanner |
| | in iPAD in store 8100 or a keyboard on lane 1 machine |
| | in store 8100 in US. It can also report the data format and |
| | other specifications about the PU if necessary. |
| Action | As an effect of join message PU should become enabled |
| | to send and receive messages to participate in system. |
| | Leave message should have the reverse effect of above. |
| Level | 0 |
| Effect | Internal Effecter |
| Distance | Up to provider, 1 |
| Life | Non-spatial a-cyclical |
| Security | Authorization? |
| Frequency | Must be only one per effect |
| Size | Must be within small to medium (internal effecter) size |
| | messages |
| Frequency | Must be only one per effect |
| Importance | High |
| MUM Impact | None to medium |
| ETT | 1 millisecond plus up to 5 seconds for connection |
| | establishment |
| ATT | 10 Seconds |
| KB | For join only |
| | a) Server where the provider lives |
| | b) Provider name |
| | c) Communication type |

Enable - Disable Messages

| Layer Name | Enabler |
|---|---|
| Description | These messages will originate from higher level layers |
| | e.g. 5, 6 and 7. Messages will be consumed by the |
| | enabler layer and switch the functionality on or off |
| | without making it leave the system. |
| Action | Enable should allow the PU to send receive data |
| | messages into system, this is default with Join. |
| | Disable should allow the PU to stop sending or receiving |
| | data messages (external effecters) but still keep receiving |
| | and working with internal effecters. So PU becomes |
| | disabled but enabler layer keeps participating in the |
| | system. |
| Level | 5, 6, 7 |
| Effect | Internal Effecter |
| Distance | Up to enabler, maximum 7 |
| Life | Spatial a-cyclical |
| Security | Authorization? |
| Frequency | Must be only one per effect |
| Size | Must be within small to medium (internal effecter) size |
| | messages |
| Importance | High |
| MUM Impact | None to medium |
| ETT | 1 millisecond plus up to 5 seconds for connection |
| | establishment |
| ATT | 100 ms |
| KB | Originator of the message must know which enabler's |
| | state is going to be changed the knowledge elements |
| | must contain the enabler name and locale information |
| | for making it unique. If locale information is missing |
| | then all enablers with this name in current scope will |
| | change state. Enabler must know its existing state. |

Non-Admin Messages:

External Effecter messages:

| Layer Name | Enabler |
|---|---|
| Description | All messages to and from the PU are routed through the |
| | enabler, enabler must suppress or forward them to |
| | provider depending upon its state of enabled or disabled |
| | in conjunction with connected or not connected state. |
| | If enabler is unable to forward a message it must |
| | respond appropriately to the PU. If enabler has |
| | suppressed a message and PU is going to wait on it for |
| | ever PU must be updated if possible of the situation. |
| | Enabler will date time stamp the message on its way out, |
| | an incoming message might not need date time stamp. |
| Action | No net effect on enabler state |
| Level | NA |
| Effect | External Effecter |
| Distance | NA |
| Life | NA |
| Security | NA |
| Frequency | NA |
| Size | NA |
| Importance | High |
| MUM Impact | NA |
| ETT | NA |
| ATT | NA |
| KB | NA |

Messages from Provider:

Admin Message(s):

Register - Un-register

| Layer Name | Provider |
|---|---|
| Description | Message coming from provider into the discovery layer |
| | registering/un-registering and identifying itself in the |
| | discovery. Provider must inform discovery of its locale |
| | and function name/id while registering. |
| Action | Discovery layer's state should change and this particular |
| | provider should become available or unavailable as a |
| | consequence of the message. |
| Level | 2 |
| Effect | Internal effecter |
| Distance | 1 |
| Life | Non-spatial acyclical |
| Security | ? |
| Frequency | One per effect |
| Size | Small |
| Importance | High (receipt might be needed.) |
| MUM Impact | Very small to none |
| ETT | 0.1 ms |
| ATT | 0.1 ms |
| KB | Must know which discovery system to attach to and |
| | following ids must be known |
| | 1. Machine and port where to connect |
| | 2. Provider name/id |
| | 3. Provider locale |

Non-Admin Message(s):
External effecter messages passing through the provider. Provider might be merged with IO layer performing message suppression, replication and transformation. This is major layer while temporo-spatial and message space transformation effects can be applied for external effecter messages.
Messages from Component Discovery Service (CDS):

Admin Message(s):

Register - Un-register

| Layer Name | CDS |
|---|---|
| Description | These messages will allow a discovery service to be |
| | registered with orchestrators. CDS must inform of its |
| | locale scope to the orchestrator so that component in a |
| | particular locale can be consumed by composer layers. |
| Action | Orchestrator should become aware of the discovery in a |
| | particular locale. |
| Level | 3 |
| Effect | Internal effecter |
| Distance | 1 |
| Life | Non-spatial acyclical |
| Security | ? |
| Frequency | 1 per effect |
| Size | Small |
| Importance | High |
| MUM Impact | Small |
| ETT | 0.1 ms |
| ATT | 0.1 ms |
| KB | Must have a way of knowing where the orchestrator is |
| | present and how to send messages to it. Must know its |
| | locale and id information |

Receipt for provider registration - un-registration

| Layer Name | CDS |
|---|---|
| Description | These messages will allow a provider to confirm if it has |
| | successfully registered or un-registered from component |
| | discovery system. |
| Action | Provider layer is made aware of its state with CDS layer |
| Level | 3 |
| Effect | Internal effecter |
| Distance | −1 |
| Life | Non-spatial acyclical |
| Security | ? |
| Frequency | 1 per effect |
| Size | Small |
| Importance | High |
| MUM Impact | Small |
| ETT | 0.1 ms |
| ATT | 0.1 ms |
| KB | Provider's name/id and locale |

Booking/Releasing and Query result

| Layer Name | CDS |
|---|---|
| Description | This is the result of a query originating from any layer |
| | wanting to know about the availability of a particular |
| | resource within a given locale. The query might contain |
| | “interest”, “book”, “information” and “release” status. |
| Action | If resource is unavailable a resource not available |
| | message is sent otherwise resource is declared consumed |
| | and is tied to query sender. If a release request is sent |
| | then the layer must declare the component as free and |
| | optionally inform the interested parties waiting in queue |
| | to use it. |
| Level | 3 |
| Effect | Internal effecter |
| Distance | 1 . . . * |
| Life | Non-spatial acyclical |
| Security | ? |
| Frequency | 1-* per effect (given that interested parties may be |
| | contacted in future for same action.) |
| Size | Small |
| Importance | High |
| MUM Impact | Small |
| ETT | 0.1 ms |
| ATT | 0.1 ms |
| KB | Must know which entity to send receipt or response to |

Non-Admin Message(s):
None
Messages from Composition:

Admin Message(s):

Register - Un-register

| Layer Name | Composition |
|---|---|
| Description | These messages will allow a composition to be formed |
| | and registered/un-registered with orchestrator. |
| Action | Orchestrator will become aware of a particular |
| | composition system to be present or absent from the |
| | system. |
| Level | 4 |
| Effect | Internal effecter |
| Distance | 1 |
| Life | Non-spatial acyclical |
| Security | ? |
| Frequency | 1 per effect |
| Size | Small |
| Importance | High |
| MUM Impact | Small |
| ETT | 0.1 ms |
| ATT | 0.1 ms |
| KB | Must know which orchestrator to update so general |
| | machine and locale information necessary to reach the |
| | orchestrator must be present. Also know what is the |
| | composition semantics, parts and name/id |

Discover/Consume and Release messages

| Layer Name | Composition |
|---|---|
| Description | These messages will originate from composition and can |
| | query the discovery system to know if a particular |
| | resource (name, locale) is available (“Information”) or is |
| | available and can be consumed (“Consume”) or is |
| | already consumed and needs to be released (“Release”) |
| | or this composition has an interest in this resource when |
| | it becomes available (“Interest”). |
| Action | Discovery will only provide device status if it is |
| | “Information” message only, in all other cases a change |
| | in discovery status will occur which will cause a |
| | particular resource to become free, consumed or booked |
| | in future. |
| Level | 4 |
| Effect | Internal effecter |
| Distance | −1 |
| Life | Non-Spatial acyclical |
| Security | ? |
| Frequency | 1 per effect or more than one in case of future effects |
| Size | Small |
| Importance | High |
| MUM Impact | Small |
| ETT | 0.1 ms |
| ATT | 0.1 ms |
| KB | Must know how to reach the discovery |
| | Must know what resource it is looking for in terms of |
| | name/id and locale. |

Composition State

| Layer Name | Composition |
|---|---|
| Description | This message is sent to any requestor who want to know |
| | what is the composition state in terms of current activity, |
| | is forming, is complete, is waiting, is releasing is in |
| | error, or is shutdown. |
| Action | Requestor is sent a report of composition state and |
| | individual PUs state. |
| Level | 4 |
| Effect | Internal effecter |
| Distance | 1 . . . * |
| Life | Spatial acyclical |
| Security | ? |
| Frequency | 1 per request |
| Size | Small to medium |
| Importance | Medium |
| MUM Impact | Small |
| ETT | 0.2 ms |
| ATT | 0.2 ms |
| KB | Must know the state |

Non-Admin Message(s):
None

Messages from Responsibility:

Admin Message(s):
Start/Stop Composition

| Layer Name | Responsibility |
|---|---|
| Description | This message will enable or disable a particular |
| | composition from work. These messages can be |
| | generated as a reaction to effects by orchestrator. |
| Action | The composition will consume or release devices |
| | according to message type. Message must contain a time |
| | out for a full composition; if devices could be acquired |
| | during this time composition and responsibility will go |
| | live otherwise responsibility will be assumed to be |
| | non-functional. |
| Level | 5 |
| Effect | Internal effecter |
| Distance | 1 |
| Life | Non-spatial acyclical |
| Security | ? |
| Frequency | 1 per effect |
| Size | Small-medium |
| Importance | High |
| MUM Impact | Small |
| ETT | 0.1-500 ms |
| ATT | 1s |
| KB | Must know which composition to instantiate and must |
| | know what timeout to provide. |

| | |
|---|---|
| Layer Name | Responsibility |

Responsibility State

| | |
|---|---|
| Description | This will be a response message sending the state of |
| | responsibility including the states of all compositions. |
| Action | Requestor should become fully aware of the state of |
| | responsibility. |
| Level | 5 |
| Effect | Internal effecter |
| Distance | 1 . . . * |
| Life | Non-spatial acyclical |
| Security | ? |
| Frequency | 1 per effect |
| Size | Small-medium |
| Importance | High |
| MUM Impact | Small |
| ETT | 0.1-2000 ms |
| ATT | 10s |
| KB | Must know which composition to instantiate and must |
| | know what timeout to provide. |

Responsibility Available types

| | |
|---|---|
| Description | A message from any requester trying to know the flavors |
| | of responsibility available so an appropriate responsibility |
| | flavor can be instantiated. |
| Action | Requester becomes aware of all available flavors |
| | (flavor type is left to implementation.) |
| Level | 5 |
| Effect | Internal effecter |
| Distance | 1 . . . * |
| Life | Non-spatial a cyclical |
| Security | ? |
| Frequency | 1 per effect |
| Size | Small-medium |
| Importance | High |
| MUM Impact | Small |
| ETT | 0.1-2000 ms |
| ATT | 10s |
| KB | For requester: Which responsibility to talk to |
| | For responsibility: What flavors are resent and what |
| | flavors can be offered according to the level of |
| | requester's clearance. |

Non-Admin Message(s):
None

Messages from Orchestrators/Orchestrator Manager:

Orchestrate

| Layer Name | Orchestrator/Orchestrator Manager |
|---|---|
| Description | This message will instantiate/Un-instantiate a particular |
| | responsibility. |
| Action | Responsibility will be activated or deactivated |
| Level | 6, 7 |
| Effect | Internal effecter |
| Distance | 1 |
| Life | Non-spatial acyclical |
| Security | ? |
| Frequency | NA |
| Size | Small |
| Importance | High |
| MUM Impact | Small |
| ETT | 0.1-2000 ms |
| ATT | 10s |
| KB | Must know which responsibility in terms of id and locale |
| | and must know when to instantiate. |

State

| Layer Name | Orchestrator/Orchestrator Manager |
|---|---|
| Description | This message will provide a complete system state to |
| | requestor. An interested awareness level must be |
| | specified as the volume of information can be too great. |
| Action | Requestor will become aware to the level requested. |
| Level | 6, 7 |
| Effect | Internal effecter |
| Distance | 1 . . . * |
| Life | Non-Spatial acyclical |
| Security | ? |
| Frequency | 1 per effect |
| Size | Medium to large |
| Importance | High |
| MUM Impact | Small to medium |
| ETT | 1-5s |
| ATT | 30s |
| KB | Must know the states of all responsibilities being |
| | orchestrated by this system. Must know where to send |
| | the response |

Synch Messages

| Layer Name | Orchestrator/Orchestrator Manager |
|---|---|
| Description | This group of messages will allow the orchestrator |
| | managers to synchronize the interaction between |
| | orchestrators. |
| Action | Orchestrators will receive send information required to |
| | run the system in a synchronous fashion. |
| Level | 7 |
| Effect | Internal effecter |
| Distance | 1 . . . * |
| Life | Spatial cyclical |
| Security | ? |
| Frequency | Threshold |
| Size | Medium to large |
| Importance | High |
| MUM Impact | Small to medium |
| ETT | 0.1 to 1s |
| ATT | 2s |
| KB | Must know what orchestrators are running and how to |
| | approach them for state and activity messages. |

Non-Admin Message(s):
None

What is claimed is:

1. A system for managing a deployment of components to fulfill a requirement, comprising:
a responsibility controller operable to define a plurality of functions performed to satisfy the requirement, the plurality of functions being defined in a manner which does not include defining an association between each function and a respective component;
a composition controller operable to define an affiliation between a plurality of components, the affiliation defining a configuration of the components, the configuration being organized to provide a capability to perform the plurality of functions to satisfy the requirement; and
an orchestration controller operable to define a relationship between the plurality of functions defined by the responsibility controller and the configuration defined by the composition controller, such that the components in the configuration provide the capability to perform the functions to satisfy the requirement.

2. The system of claim 1, wherein each of the responsibility controller, composition controller and orchestration controller is implemented via software.

3. The system of claim 1, further comprising the plurality of components.

4. The system of claim 1, wherein the composition controller is further operable to define a plurality of configurations of components, and wherein the orchestration controller is further operable to receive and process an instruction to modify a relationship between one of the plurality of configurations and a plurality of functions defined by the responsibility controller.

5. The system of claim 4, wherein modifying the relationship includes at least one of creating a new relationship between one of the configurations and a plurality of functions, and eliminating an existing relationship between one of the configurations and a plurality of functions.

6. The system of claim 4, wherein the orchestration controller is further operable to receive and process an instruction to modify a relationship, which instruction is received from one of the plurality of components.

7. The system of claim 1, wherein the system further comprises a communication service which, upon a relationship being formed between the plurality of functions and the configuration, is operable to facilitate communication among at least some of the components in the configuration to perform the plurality of functions.

8. At least one computer-readable medium having instructions recorded thereon, which instructions, when executed, perform a method for managing a deployment of components to fulfill a requirement, the method comprising acts of:
(A) defining a plurality of functions performed to satisfy a requirement, the functions being defined in a manner which does not include defining an association between each function and a respective component;
(B) defining an affiliation between a plurality of components, the affiliation defining a configuration of the components, the configuration being organized to provide a capability to perform the plurality of functions to satisfy the requirement; and
(C) defining a relationship between the plurality of functions defined in act (A) and the configuration defined in act (B), such that the components in the configuration provide the capability to perform the functions to satisfy the requirement.

9. The at least one computer-readable medium of claim 8, wherein the act (B) further comprises defining a plurality of configurations of components, and wherein the method further comprises an act of:
(D) processing an instruction to modify a relationship between one of the plurality of configurations and a plurality of functions defined by the responsibility controller.

10. The at least one computer-readable medium of claim 9, wherein modifying a relationship includes at least one of creating a new relationship between one of the configurations and a plurality of functions, and eliminating an existing relationship between one of the configurations and a plurality of functions.

11. The at least one computer-readable medium of claim 9, wherein the act (D) further includes processing an instruction received from one of the plurality of components to modify a relationship.

12. The at least one computer-readable medium of claim 8, wherein the method further comprises an act of:
(E) providing a communication service which, upon a relationship being formed during the act (C) between the plurality of functions and the configuration, is operable to facilitate communication among at least some of the components in the configuration to perform the plurality of functions.
